(19) United States
(12) Patent Application Publication
(10) Pub. No.: US 2006/0089884 A1
(43) Pub. Date: Apr. 27, 2006

(54) Systems and methods for communicating information between a customer and a supplier

(75) Inventors: Robert R. Wampler, Augusta, KS (US); Gary W. Giles, Elbing, KS (US)

Correspondence Address: BLACK LOWE & GRAHAM PLLC, 701 FIFTH AVENUE, SUITE 4800, SEATTLE, WA, 98104, US

(73) Assignee: The Boeing Company

(21) Appl. No.: 10/974,283

(22) Filed: Oct. 27, 2004

(51) Int. Cl. G06Q 30/00

(52) U.S. Cl. 705/26

(57) ABSTRACT

Systems and methods for exchanging information between a customer and a supplier are disclosed. In one embodiment, a system includes a customer system that receives customer data from a customer, and a corresponding supplier system that receives supplier data generated by the supplier. A communications system between the customer system and the supplier system permits data to be interchanged. In another embodiment, a method includes accessing one of a customer system and a supplier system, and identifying information residing on one of the customer system and the supplier system. A transfer of the identified information is then requested so that the identified information is transferred over the communications network. In still another embodiment, a method includes authorizing a user to gain access to the system, and selecting a desired functional operation on the system. The selected functional operation is then transmitted.

### FIELD OF THE INVENTION

This invention relates generally to information technology, and more particularly, to systems and methods for exchanging information between a customer and a supplier.

### BACKGROUND OF THE INVENTION

Many machining and forming processes are presently performed using machine tools that operate under numerical control (NC). In a typical NC machine installation, a set of programmed instructions is processed by a machine tool unit (MTU) that provides motion control signals to servomechanisms coupled to the machine tool. A work piece retained by the machine tool is thus formed into a finished part according to the processed instructions. The instructions are typically prepared by machine tool programmers who develop the instructions based upon available geometrical information for the finished part, which generally includes drawings of the part, either in paper or electronic form. The machine tool programmers also typically include process-related instructions, which may include feed rates for the work piece and even the selection of one or more forming tools such as drills, end mills, or other like forming tools that are driven by the NC machine. The programmed instructions are generally encoded on a variety of transportable memory devices, which may include punched tapes, magnetic tapes or disks, or optical disks. The programmed instructions are then introduced to the MTU from the transportable memory device using a reader configured to read the transportable memory device.

Occasionally, errors occur when the instructions are programmed that result in one or more defects in the finished part. For example, incorrect geometrical information may be encoded in the instructions so that a part is produced having physical dimensions that differ from the desired dimensions. Programming errors may also include process-related information, so that the work piece may, for example, be subjected to an incorrect feed rate during a portion of the machining process. Still other process-related programming errors may include the encoding of machining processes in an incorrect and/or incompatible sequence.

Accordingly, in order to minimize the additional costs incurred through lost production time, NC machine operators may alter the instructions on the transportable memory device, or even add additional instructions to the device to mitigate the effect of programming errors. Although these “ad-hoc” corrections generally address the errors or shortcomings present in the programmed instructions, the corrections are often not communicated to the programmers since an appropriate and bi-directional means of communications may not exist. As a result, different machine operators may make different alterations to the same programmed instructions, which may lead to undesired and costly production time variations associated with the part. More ominously, machine operators may make alterations to the programmed instructions that introduce undesired differences between the finished part and a desired configuration. Such differences may incur still other increases in production costs due to an increased scrap rate, and through the need for more vigorous part inspection efforts.

Still other problems exist in current NC machine systems even in the absence of errors in the programming instructions. For example, since the transportable memory device is readily concealable and portable, the programmed instructions may be misappropriated and transferred to others that may use the instructions to produce “counterfeit” parts, which lack appropriate authorization or approval from the manufacturer.

Accordingly, what is needed is an interactive and bi-directional system and method for transferring information that allows errors to be readily identified and corrected, and that reduces the likelihood that the information is misappropriated.

### SUMMARY OF THE INVENTION

The present invention comprises systems and methods for exchanging information between a customer and a supplier. In one aspect, a customer-supplier support system includes a customer system configured to receive customer data generated by the customer, and a corresponding supplier system spaced apart from the customer system and configured to receive supplier data generated by the supplier. A communications system is interposed between the customer system and the supplier system that is operable to transfer the customer data to the supplier system and to transfer the supplier data to the customer system.

In another aspect, a method of transferring information between a customer and a supplier includes accessing one of a customer system and a supplier system, and identifying information residing on one of the customer system and the supplier system. A transfer of the identified information is then requested so that the identified information is transferred over the communications network. In still another aspect, a method of accessing a customer-supplier manufacturing support system includes authorizing a user to gain access to the system, and selecting a desired functional operation on the system. The selected functional operation is then transmitted.

### BRIEF DESCRIPTION OF THE DRAWINGS

Preferred and alternate embodiments of the present invention are described in detail below with reference to the following drawings.

FIG. 1 is a customer-supplier manufacturing support system according to an embodiment of the invention;

FIG. 2 is a flowchart that describes a method of transferring information between a customer and a supplier according to an embodiment of the invention;

FIG. 3 is a flowchart that describes a method of accessing the customer-supplier manufacturing support system of FIG. 1, according to another embodiment of the invention;

FIG. 4 is a graphical user interface for accessing the customer-supplier manufacturing support system of FIG. 1, according to another embodiment of the invention;

FIG. 5 is a graphical user interface for accessing the customer-supplier manufacturing support system of FIG. 1, according to another embodiment of the invention; and

FIG. 6 is a graphical user interface for accessing the customer-supplier manufacturing support system of FIG. 1, according to another embodiment of the invention.

### DETAILED DESCRIPTION OF THE INVENTION

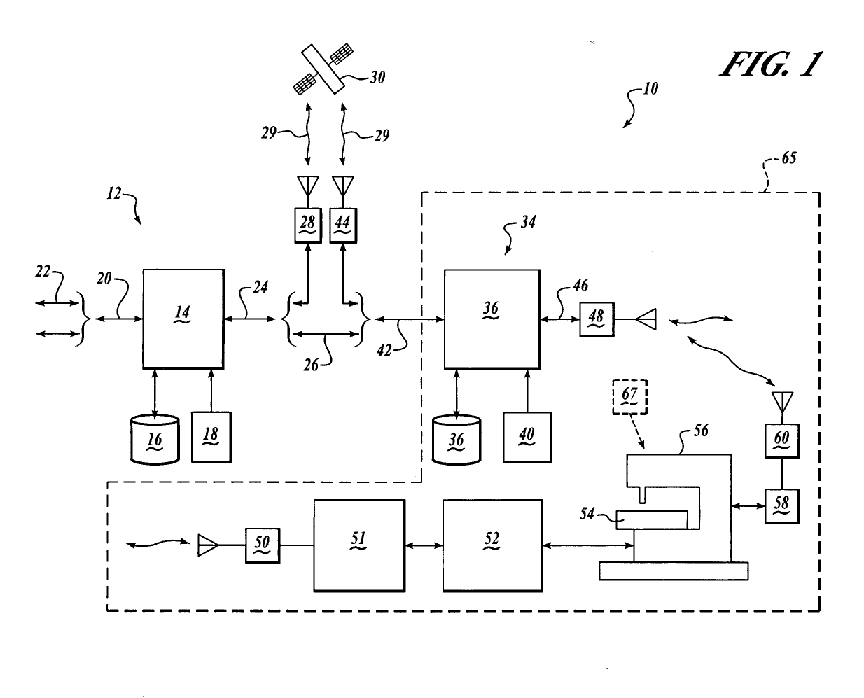

The present invention relates generally to systems and methods for exchanging information between a supplier and a customer in a manufacturing environment. Many specific details of certain embodiments of the invention are set forth in the following description and in FIGS. 1 through 6. One skilled in the art, however, will understand that the present invention may have additional embodiments, or that the present invention may be practiced without several of the details described in the following description and drawings.

In general, systems and methods in accordance with the present invention may advantageously enable the secure, bi-directional transfer of information between a supplier and a customer for the exchange of multiple types of information, including, for example, engineering Computer Aided Design (CAD) information, machine instruction Computer Aided Manufacturing (CAM) information, quality, scheduling, and performance information. Embodiments of the present invention may utilize encryption, and may provide protected access through the use of passwords or other identifier information. Furthermore, embodiments of the present invention may enable the distribution of information to non-stationary locations in support of customer requirements, such as, for example, the immediate replacement of damaged parts.

FIG. 1 is a customer-supplier manufacturing support system 10 according to an embodiment of the invention. In the following discussion, “customer” will be understood to represent an entity or organization that receives goods, data and/or services from a “supplier”. Accordingly, the customer generally defines the product, in terms of design data, product specifications, or other similar information. In contrast, the supplier generally receives the design data and product specifications and responds to the information provided to periodically provide a product to the customer. The customer and the supplier may be different divisions or portions of a single business entity, or alternately, the customer and the supplier may be separate business entities. In either case, the system 10 includes a customer system 12 that is typically positioned at a customer's physical location. The customer system 12 includes a customer processor 14 operable to receive programmed instructions and data, and to process the data according to the received instructions. The customer processor 14 is further coupled to a mass storage device 16, such as a disk drive. The mass storage device 16 may be internal to the processor 14 (not shown in FIG. 1), or it may be external to the processor 14 (as shown in FIG. 1), and is generally configured to securely store data. The customer system 12 also includes an input/output device coupled to the customer processor 14, which may comprise a visual display terminal 18 that allows information generated by the customer system 12 to be viewed, and that also permits information to be transferred to the customer system 12, by means of a keyboard, a touch screen apparatus, a mouse, or other similar devices. The customer processor 14 in combination with the visual display terminal 18 may be programmed to enable multiple simultaneous views, known commonly as “windows”, to provide a user with visual access to multiple processes. Information may be exchanged with the customer processor 14 through an internal communications port 20 that is operable to communicate with the internal data sources maintained by the customer. Accordingly, the internal communications port 20 may be configured to exchange data 22 with a local area network (LAN), an Ethernet, a modem coupler, or any other communications system maintained by the customer.

The customer system 12 further includes an external communications port 24 that may be configured to communicate with external systems through a land-based communications line 26 such as a telephone line, digital subscriber line (DSL), an integrated services digital network (ISDN), a coaxial cable-based system using a cable modem, or other similar devices. In a particular embodiment, the external communications port 24 is coupled to a transceiver 28 that is operable to communicate wireless signals 29 through a communications satellite 30.

With continued reference to FIG. 1, the system 10 further includes a supplier system 34 that is typically spaced apart from the customer system 12 that is generally positioned at a supplier's physical location. The supplier system 34 includes a supplier processor 36 operable to receive programmed instructions and data, and to process the data according to the received instructions. The supplier processor 36 is coupled to a mass storage device 38, which may be internal to the supplier processor 36, or external to the processor 36 (as shown in FIG. 1). The supplier system 34 is further coupled to an output device, which may include a visual display terminal 40 that allows information generated by the supplier system 34 to be viewed, and that further permits information to be transferred to the supplier system 34 by means of a keyboard, a touch screen apparatus, a stylus, a mouse, or other similar devices. The supplier processor 36 in combination with the visual display terminal 40 may also be programmed to enable multiple simultaneous views to be perceived by a user, so that the user may be provided with visual access to multiple processes generated by the supplier processor 36. The supplier processor 36 includes an external communications port 42 that may be configured to communicate with the customer system 12 through the land-based communications line 26, or preferably through the communications satellite 30 by means of a transceiver 44 coupled to the supplier processor 36.

The supplier processor 36 also includes an internal communications port 46 that is operable to communicate through a transceiver 48 so that wireless signals may be exchanged with a corresponding transceiver 50 that is coupled to a post-processor 51 that is operable to generate “high level” machine tool instructions that describe the locations of features on a work piece 54 where a forming operation is to occur. The post processor 51 is coupled to a machine tool unit (MTU) 52 that is operable to accept the machine tool instructions and control the motion of a machine tool 56 so that the work piece 54 may be subjected to the desired forming operations. In FIG. 1, a single MTU 52 is shown coupled to the post-processor 51, as is commonly found in a computer numerical control (CNC) system. It is understood, however, that other arrangements are possible. For example, a plurality of machine tool units and machine tools may operate under the centralized control of the post-processor 51, which is commonly found in a distributed numerical control (DNC) system.

The machine tool 56 is coupled to a monitoring system 58 that is operable to directly determine selected information from the work piece 54 and communicate the information to the supplier processor 36 through a transceiver 60. The selected information may include, for example, dimensional information obtained from the work piece 54 as described in detail in U.S. Pat. No. 5,796,619 to Wampler, and entitled “METHOD AND APPARATUS FOR NUMERICALLY CONTROLLED PROBING”, which is incorporated by reference. The monitoring system 58 may also be configured to examine selected portions of the work piece 54 and to compile statistical data based upon the examination that may be used to compile inspection reports. Further, the monitoring system 58 may be employed to collect schedule or production-related information. Schedule data may be used to assist the customer in the implementation of so-called “just-in-time” manufacturing methods that seek to minimize the inventory held by the customer. Schedule data may also be used to determine if a supplier is producing more finished parts than the customer requested, thereby allowing the customer to deter the production of an unauthorized quantity of components. Production-related data may be used to measure the efficiency of the supplier, thus allowing the customer to more effectively control costs. Although FIG. 1 shows the monitoring system 58 coupled to the machine tool 56, it is understood that the monitoring system 58 may alternately be coupled to other components of the system 10, including the MTU 52 or the post-processor 51.

In one embodiment, at least one of the customer system 12 and the supplier system 34, and preferably both, may be equipped with software instructions adapted to operate on either of the processor 14 and 36 and adapted to enhance the information flow between the customer system 12 and the supplier system 34. In one particular embodiment, the software instructions are adapted to operate in accordance with the methods of information exchange as disclosed in co-pending, commonly owned U.S. patent application Ser. No. 09/981,949 entitled “A Manufacturing Method and Software Product for Optimizing Information Flow” filed on Oct. 1, 2001, which application is incorporated by reference.

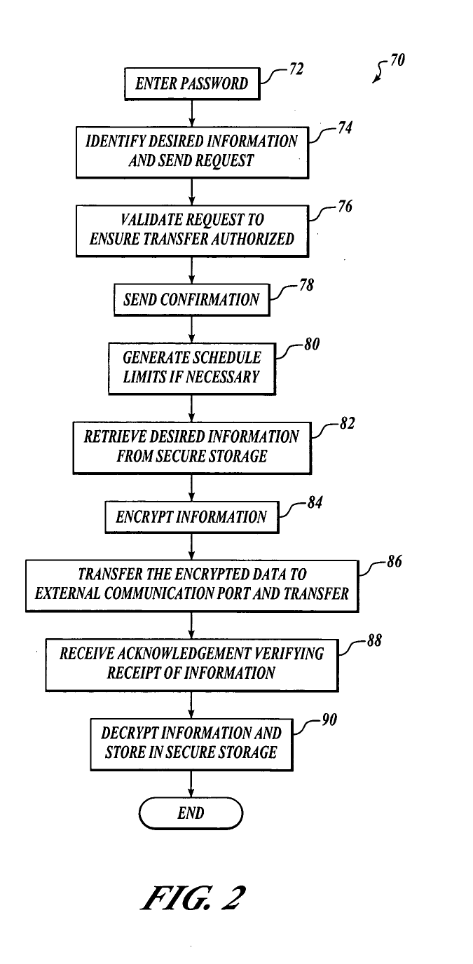

FIG. 2 is a flowchart that will be used to describe a method 70 of transferring information between a customer and a supplier according to an embodiment of the invention. Since the system 10 of FIG. 1 advantageously supports a bi-directional transfer of information between the customer and the supplier, the customer system 12 and the supplier system 34 exhibit functional symmetry in selected aspects. Accordingly, the method 70 may be implemented on either the customer system 12 or the supplier system 34. At block 72, access to the system 10 of FIG. 1 is controlled by entering a password, employing a security token, or by otherwise satisfying one or more conditions that guarantee that a user is authorized to access the system 10. At block 74, the desired information to be transferred is identified, and a request is placed through the visual display terminal 40, when the supplier is requesting the transfer, or through the visual display terminal 18, when the customer is requesting the transfer. The terminal 18 and the terminal 40 are configured to host a graphical user interface (GUI) to facilitate placing the request. An embodiment of the GUI will be described in further detail below. The desired information may be identified, for example, by entering a part number, a drawing number, a document number, or any other unambiguous identifier. At block 76, the request is validated to ensure that the requester is authorized to receive the requested information. For example, if the customer system 12 is requesting inspection data from the supplier system 34, the supplier system 34 would verify that the customer system 12 was authorized to receive the inspection data. Similarly, if the supplier system 34 is requesting detailed drawings of a selected part, the customer system 12 would verify that the supplier system 34 is authorized to receive the requested drawings. At block 78, a confirmation is sent if the requestor is authorized to receive the requested information.

Still referring to FIG. 2, a schedule limit is generated at block 80, if required. For example, if the supplier system 34 is requesting drawing information from the customer system 12, the customer system 12 may impose a schedule limit so that the requested information is not released to the supplier system 34 until it is needed to support the manufacture of a requested part by the supplier. Similarly, the customer system 12 may impose a time limit on information that is transferred to the supplier system 34, so that the information expires after a predetermined period of time. The supplier system 34 may also impose schedule limits. For example, the supplier system 34 may decline to send inspection data or statistical reports, or other information until the manufacture of the requested parts has been completed.

At block 82, the requested information is retrieved from the secure mass storage device 16 of the customer system 12, if the transfer is from the customer system 12 to the supplier system 34, or correspondingly, from the secure mass storage device 38 of the supplier system 34 if the requested transfer is from the supplier system 34 to the customer system 12. In either case, the retrieved information is encrypted at block 84. The encryption scheme may employ either the well-known private (or secret) key encryption, or it may rely upon public key encryption, thus affording greater security if encryption speed is not a concern. Preferably, a public key encryption method is combined with a private key method in a “digital envelope” method to provide an enhanced level of security with greater speed. At block 86, the encrypted information is transferred to the external communications port 24 of the customer system 12, or alternately, to the external communications port 42 of the supplier system 34, depending on whether the request originated with the supplier system 34 or the customer system 12. The data is then transferred by wireless means through the communications satellite 30, or alternately by means of the land-based communications line 26. An acknowledgement of receipt may then be sent, as shown in block 88. At block 90, the received information may be decrypted and stored on the secure mass storage device 18 of the customer system 12, or the secure mass storage device 38 of the supplier system 36.

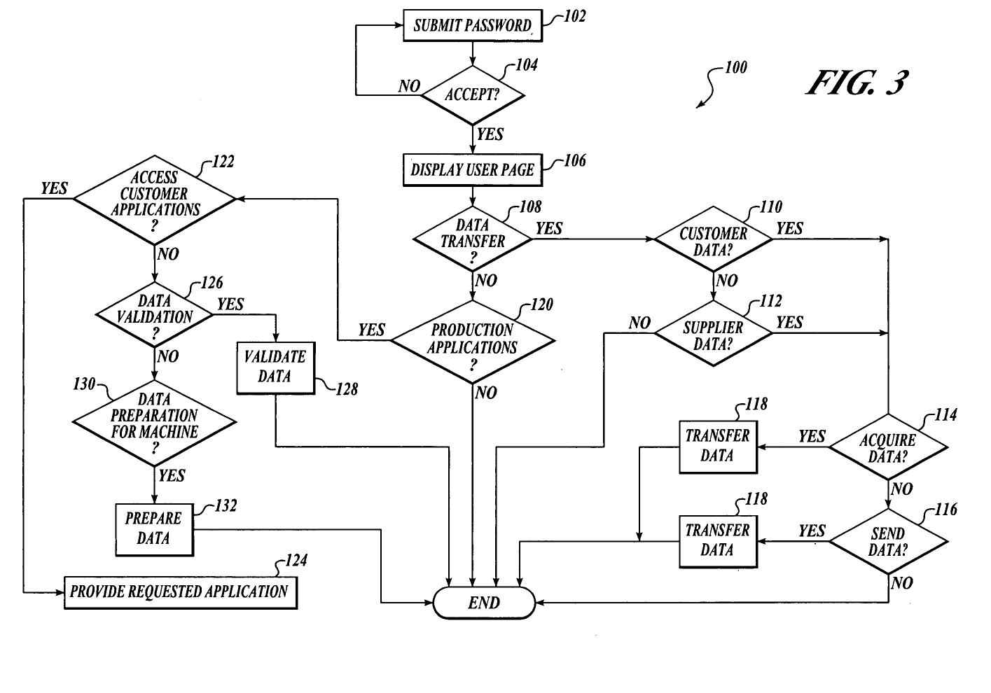

FIG. 3 is a flowchart that will be used to describe a method 100 of accessing the customer-supplier manufacturing support system 10 of FIG. 1, according to another embodiment of the invention. The method 100 may be implemented on the customer system 12 and the supplier system 34 to initiate information requests and to facilitate the transfer of information between a customer and a supplier. In one particular embodiment, the method 100 is implemented using a GUI, so that a user is provided with structured options that are displayed on the visual display terminals 18 and 40 to provide the user with a convenient means of access. Other embodiments of the invention, however, may not employ a GUI, and may provide fewer options to a user. As shown in FIG. 3, at block 102, a user accesses the system 10 by entering a password, or otherwise satisfying any condition that guarantees that the user is authorized to access the system 10. At block 104, access to the system may be accepted or denied based upon the password, or other information provided at block 102. When the user is authorized, a user page is displayed on the terminal 18 or the terminal 40, depending upon whether the user is associated with the customer or the supplier, as shown in block 106. At block 108, the user indicates whether a data transfer is desired. If a data transfer is desired, at block 110 the user may elect to transfer customer data, or alternately, at block 112, the user may elect to transfer supplier data. In either case, the type of data transfer is specified at blocks 114 and 116, where the user elects to acquire data or send data, respectively. At block 118, the user initiates the transfer of the requested data.

Still referring to FIG. 3, if the user does not desire to initiate a data transfer at block 108, the user may elect to access various production-related applications at block 120, and may further elect to access customer applications at block 122. The customer applications may include, for example, computer aided drawing (CAD) viewers, computer aided manufacturing (CAM) applications, quality report generation applications, scheduling an/or performance report generation applications, and the like. At block 124, the requested customer application is accessed. Still other applications are also accessible at block 122. For example, the user may elect to perform a data validation at block 126, wherein the data transferred to a supplier is subjected to a data analysis that verifies that the data is current, and includes the most recent revision, and that the data has been properly tested in simulated forming procedures. Accordingly, the data is validated at block 128. At block 130, the user may elect to prepare the data for use on a selected machine tool installation. Accordingly, the data for the selected machine is prepared at block 132.

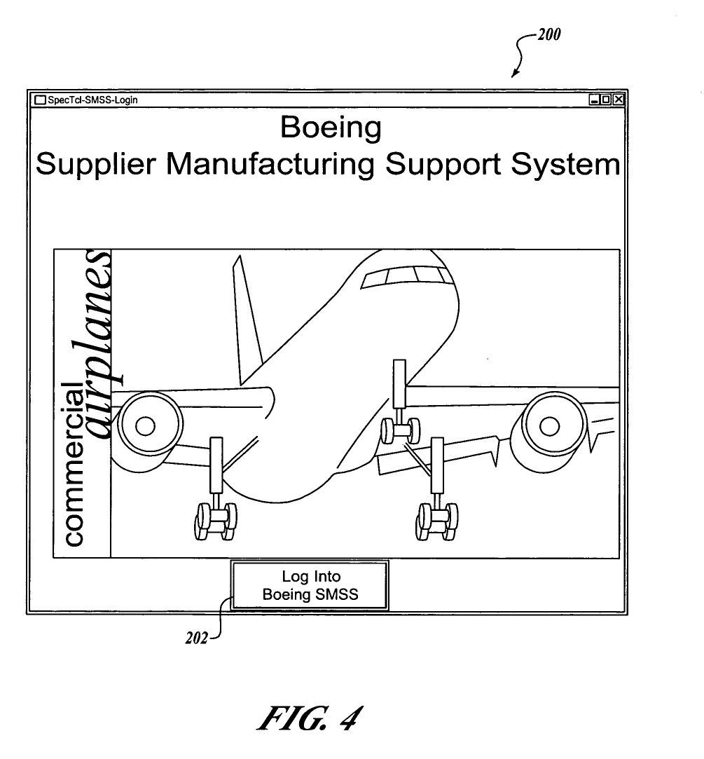

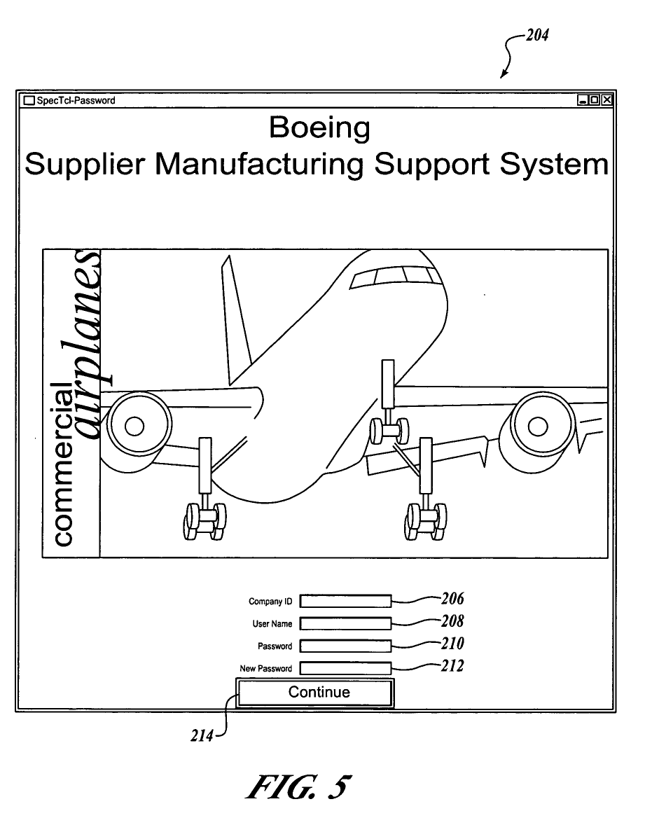

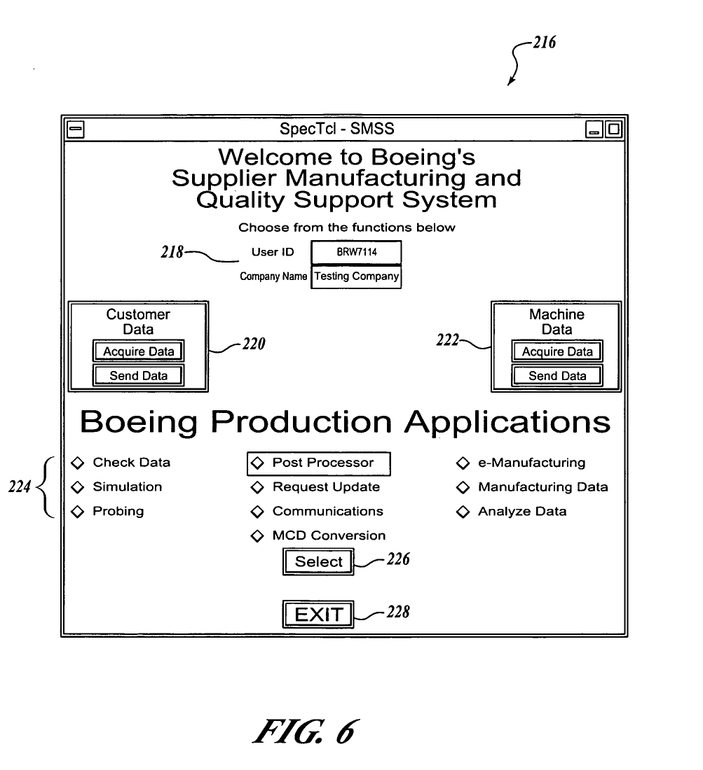

FIGS. 4 through 6 are graphical user interfaces for accessing the customer-supplier manufacturing support system 10 of FIG. 1, according to still another embodiment of the invention. With reference first to FIG. 4, a first graphical interface 200 includes a site 202 that may be manually actuated by a pointing device that is manipulated by user that desires access to the customer-supplier manufacturing support system 10. Upon actuation of the site 202, a second graphical interface 204 (FIG. 5) appears that requests the entry of selected information. The second graphical interface 204 may include a first site 206 for the entry of a predetermined company identifier. A second site 208 may be provided for the entry of a predetermined user name associated with one or more individuals associated with the identifier entered in site 206. A third site 210 may be provided for the entry of a selected password. If it is desired to enter a new password to replace the former password, the new password may be entered at a fourth site 212. When the desired information has been entered in the sites 206 through 212, the user may manually actuate a fifth site 214 with the pointing device. Actuation of the fifth site 214 allows access to a third graphical interface 216 (FIG. 6). The third graphical interface 216 includes a sixth site 218 that reflects the information that was entered at sites 206 and 208 in the second graphical interface 204 of FIG. 5. The third graphical interface 216 further includes a seventh site 220 for the exchange of customer data. Accordingly, the seventh site 220 also includes a provision for acquiring customer data and sending customer data that may be actuated by the pointing device. The third graphical interface 216 also includes an eighth site 222 for the exchange of machine data. The eighth site 222 also permits machine data to be acquired and sent, which may also be actuated by the pointing device.

With reference still to FIG. 6, the third graphical interface 216 may also include various other additional sites 224 that the user may optionally select to direct the system 10 of FIG. 1 to perform other functions. When one of the options in the additional sites 224 is actuated by the pointing device, such as, for example, the post processor function as shown in FIG. 6, the user may then select the function by actuating ninth site 226. Still other options may be selected by the user, such as a machine probing option that permits dimensional data collected by the MTU 52 (FIG. 1) to be transferred to the customer system 12 (also shown in FIG. 1). A suitable machine probing apparatus and method is disclosed in detail in U.S. Pat. No. 5,898,590 to Wampler and entitled “Method and Apparatus for Numerically Controlled Pattern Determination”, which is incorporated by reference. Further, an e-manufacturing option may also be selected by the user, as also shown in FIG. 6. A suitable e-manufacturing system and method is disclosed in detail in the foregoing U.S. patent application Ser. No. 09/981,949 entitled “A Manufacturing Method and Software Product for Optimizing Information Flow”, which was previously incorporated by reference. Alternately, the user may exit the system 10 by actuating a tenth site 228 on the third graphical interface 216.

Embodiments of systems and methods in accordance with the present invention may provide advantages over the prior art. Embodiments of the present invention enable the secure, bi-directional transfer of information between a supplier and a customer for the exchange of multiple types of information, (e.g. CAD information, CAM machine instructions, quality, scheduling, performance information, etc.). Embodiments of the present invention may utilize encryption, and may provide protected access through the use of passwords or other identifier information. Furthermore, embodiments of the present invention may enable the distribution of information to non-stationary locations in support of customer requirements, such as, for example, the immediate replacement of damaged parts. More specifically, in one particular application, rather than carrying a stock of replacement parts for aircraft engaged in combat on a mobile repair facility 65 (FIG. 1), such as a depot ship, the mobile repair facility (depot ship) need only carry one or more machine tools 56 and a supply of raw material 67 (e.g. aluminum stock, titanium stock, etc.) to make the replacement parts, and may safely and securely receive the manufacturing information (e.g. CAM instructions) to manufacture a particular part at the mobile repair facility as needed, eliminating the need to carry an inventory of spare parts.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A customer-supplier manufacturing support system for exchanging information between a customer and a supplier, comprising:
a customer system configured to receive customer data generated by the customer;
a supplier system configured to control a machine tool system according to the customer data to operably form a workpiece coupled to the machine tool system and to generate supplier data obtained from the workpiece; and
a communications system interposed between the customer system and the supplier system that is operable to transfer the customer data to the supplier system and to transfer the supplier data to the customer system.

2. The customer-supplier manufacturing support system of claim 1, wherein the customer system further comprises a customer processor that is operably coupled to an internal communications port to receive the customer data, and an external communications port operably coupled to the communications system.

3. The customer-supplier manufacturing support system of claim 2, wherein the customer system further comprises a mass storage device coupled to the customer processor that is configured to store the customer data, and an input/output device configured to permit a user to communicate with the customer processor.

4. The customer-supplier manufacturing support system of claim 1, wherein the supplier system further comprises a supplier processor that is operably coupled to an internal communications port to receive the supplier data, and an external communications port operably coupled to the communications system.

5. The customer-supplier manufacturing support system of claim 4, wherein the supplier system further comprises a mass storage device coupled to the supplier processor that is configured to store the supplier data, and an input/output device configured to permit a user to communicate with the supplier processor.

6. The customer-supplier manufacturing support system of claim 4, wherein the internal communications port coupled to the supplier system is configured to wirelessly communicate with at least one post-processor unit operable to generate “high level” machine tool instructions.

7. The customer-supplier manufacturing support system of claim 6, wherein the at least one post-processor unit is further coupled to a machine tool unit (MTU) operable to control a machine tool device coupled to the MTU.

8. The customer-supplier manufacturing support system of claim 7, wherein the machine tool device is coupled to a monitoring system that is configured to wirelessly communicate with the supplier system.

9. The customer-supplier manufacturing support system of claim 1, wherein the communications system comprises at least one of a wireless communications system, a satellite-based communications system, a land-based communications system, a telephone line, a digital subscriber line (DSL), an integrated services digital network (ISDN).

10. The customer-supplier manufacturing support system of claim 9, wherein the satellite-based communications system comprises a first transceiver coupled to the customer system and a second transceiver coupled to the supplier system, the first transceiver and the second transceiver being operable to exchange data through the satellite-based communications system.

11. The customer-supplier manufacturing support system of claim 9, wherein the land-based communications system comprises a first cable modem coupled to the customer system, and a second cable modem coupled to the supplier system, and a coaxial cable that couples the first modem to the second modem.

12. A method of transferring information between a customer and a supplier, comprising:
accessing at least one of a customer system and a supplier system;
if the customer system is accessed, identifying supplier information obtained from a forming process;
if the supplier system is accessed, identifying customer information related to a forming process by specifying at least one of a part number, a drawing number and a document number;
requesting a transfer of the identified information over a communications network; and
transferring the identified information over the communications network.

13. The method of claim 12, wherein accessing at least one of a customer system and a supplier system comprises providing at least one of password, a company identifier and a user name.

14. The method of claim 13, wherein accessing at least one of a customer system and a supplier system comprises validating a request to ensure a transfer is authorized.

15. The method of claim 12, wherein identifying information residing on at least one of the customer system and the supplier system comprises indicating if the identified information is to be received or if the identified information is to be transmitted.

16. The method of claim 12, wherein identifying information residing on at least one of the customer system and the supplier system comprises selecting an application that resides on the customer system and the supplier system.

17. The method of claim 12, wherein requesting a transfer of the identified information comprises retrieving the desired information from a secure storage location.

18. The method of claim 12, wherein requesting a transfer of the identified information comprises generating a schedule limit that provides a selected expiration limit on the requested transfer.

19. The method of claim 12, wherein transferring the identified information comprises at least one of encrypting the identified information before the information is communicated over the communications network, and decrypting the identified information after the information is communicated over the communications network.

20. The method of claim 12, wherein transferring the identified information comprises communicating the information to a processor, and sending a confirming receipt after the information is communicated.

21. The method of claim 12, wherein transferring the identified information comprises storing the information in a secure storage location after the information is transferred.

22. A method of accessing a customer-supplier manufacturing support system, comprising:
authorizing a user to gain access to a selected one of a customer system and a supplier system;
if the customer system is selected, then selecting a functional operation including a data acquisition, a data update and a data check;
if the supplier system is selected, then selecting a functional operation including probing data, manufacturing data and data analysis; and
transmitting the selected functional operation.

23. The method of claim 22, wherein authorizing a user to gain access to the system comprises entering at least one of a password, a company identifier and a user name in a graphical user interface (GUI).

24. The method of claim 22, wherein authorizing a user to gain access to the system comprises introducing a security token to the system.

25. The method of claim 22, wherein authorizing a user to gain access to the system comprises displaying a user page in a graphical user interface (GUI) that includes a plurality of user options.

26. The method of claim 22, wherein selecting a desired functional operation on the system comprises selecting one of a customer data function and a supplier data function.

27. The method of claim 26, wherein selecting one of a customer data function and a supplier data function comprises at least one of indicating that the data function is a data acquisition, and indicating that the data function is a data transfer.

28. The method of claim 22, wherein selecting a desired functional operation on the system comprises selecting a production application that resides on the system.

29. The method of claim 28, wherein selecting a production application that resides on the system comprises at least one of selecting a data validation application on the system, and selecting a data preparation application on the system.

30. A method of providing replacement parts, comprising:
providing a repair facility having at least one machine tool and a supply of material;
determining a part that requires replacement;
communicating an information request to a supplier facility based on the part;
receiving the information request at the supplier facility;
communicating a response from the supplier facility to the repair facility, the response including a manufacturing information portion for manufacturing the part using the at least one machine tool and the supply of material;
receiving the response at the repair facility; and
manufacturing the part at the repair facility using the machine tool and the supply of material based on the response.

31. The method of claim 30, wherein the repair facility comprises a mobile facility.

32. The method of claim 30, wherein the repair facility comprises a depot ship.

33. The method of claim 30, wherein the vehicle comprises a combat aircraft.

34. The method of claim 30, wherein at least one of the communicating an information request and communicating a response comprises encrypting a message.

35. A software product adapted to transfer information between a customer and a supplier, comprising:
a first portion adapted to access at least one of a customer system and a supplier system;
a second portion adapted to identify supplier information obtained from a forming process if the customer system is accessed;
a third portion adapted to identify customer information related to a forming process if the supplier system is accessed by specifying at least one of a part number, a drawing number and a document number;
a fourth portion adapted to request a transfer of the identified information over a communications network; and
a fifth portion adapted to transfer the identified information over the communications network.

36. The software product of claim 35, wherein the first portion is further adapted to access at least one of a customer system and a supplier system by providing at least one of password, a company identifier and a user name.

37. The software product of claim 35, wherein the first portion is further adapted to access at least one of a customer system and a supplier system by validating a request to ensure a transfer is authorized.

38. The software product of claim 35, wherein the second portion is further adapted to identify information residing on at least one of the customer system and the supplier system by indicating if the identified information is to be received or if the identified information is to be transmitted.

39. The software product of claim 35, wherein the fourth portion is further adapted to request a transfer of the identified information comprises generating a schedule limit that provides a selected expiration limit on the requested transfer.

40. The software product of claim 35, wherein the fifth portion is further adapted to transfer the identified information by at least one of encrypting the identified information before the information is communicated over the communications network, and decrypting the identified information after the information is communicated over the communications network.
